(19) United States
(12) Patent Application Publication
(10) Pub. No.: US 2021/0222853 A1
(43) Pub. Date: Jul. 22, 2021

(54) LAMP SHADE DEVICE

(71) Applicant: Julie Dunn BECK, Virginia Beach, VA (US)

(72) Inventor: Julie Dunn BECK, Virginia Beach, VA (US)

(21) Appl. No.: 16/745,553

(22) Filed: Jan. 17, 2020

(51) Int. Cl. F21V 1/14; F21V 17/16; F21V 17/06; F21V 1/12

(52) U.S. Cl. CPC F21V 1/143; F21V 1/12; F21V 17/06; F21V 17/168

(57) ABSTRACT

This application relates to a modular decorative lamp shade. The lamp shade comprises a mounting hub with inner bracing member attachably connectable to a light source, a retaining ring forming a perimeter of the mounting hub having a plurality of flat outside edges with a mounting tab centered on each flat outside edge and attachably connectable to a plurality of panels. The mounting hub further comprises a plurality of spokes having a first end connected to the inner bracing member and a second end connected to the retaining ring. The lamp shade further comprises the plurality of panels made of a transparent panel material each having an inside surface, an outside surface, and a mounting slot. The panels are attached such that each hangs perpendicular to a floor surface. The panels may include a decorative substrate and the mounting tabs may not be visible when the lamp shade is assembled.

### TECHNICAL FIELD

The present disclosure relates to a lamp shade, particularly a modular decorative lamp shade device having a plurality of panels each made of a transparent panel material with a mounting slot located on a top portion of an inside surface of the panel. The lamp shade device further includes a mounting hub attachable to a light source, such as a lamp-base, a retaining ring forming an outside perimeter of the mounting hub and having mounting tabs configured to quickly and easily connect to the plurality of panels to provide for improved ease of assembly, design, functionality, and customizability.

### BACKGROUND

Many types of lamp shades exist for covering light sources, such as table lamps, floor lamps, and the like. Typically, lamp shades are constructed of a standard covering made of a uniform, non-collapsible material that is unwieldly to package and/or ship to customers. Furthermore, existing lamp shades do not provide the customer the ability to customize the appearance of the lamp shade by the addition or substitution of various decorative designs that may be affixed to the plurality of panels that make up the modular lampshade when combined with the mounting hub. Because of the unique, interchangeable nature of the panels that may be used with the hub of the modular lampshade, the present disclosure provides for a level of customizability not found in other products. Additionally, the present disclosure provides for a product that may be conveniently disassembled into its component parts to lay substantially flat for storage and/or transportation, improving the ease with which the modular lamp shade may be stored or transported over existing lamp shade products.

The various exemplary embodiments disclosed herein solves these problems and deficiencies by providing a modular lamp shade construction, allowing the customer to both substantially customize the appearance of the lamp shade with the lamp shade device being configured to lay substantially flat when disassembled into its component parts for convenient shipping and/or transportation.

### SUMMARY

This disclosure relates to modular decorative lamp shade designs configured to allow a customer to customize the appearance of the lamp shade and for ease of storage when in transportation or not in use. For example, a modular decorative lamp shade may include a plurality of panels, with each of the panels having both an inside surface and an outside surface. The panels may be made of a transparent material and each panel may have a mounting slot located on a top portion of the inside surface of the panel. The modular decorative lamp shade may further include a mounting hub. The mounting hub may include an inner bracing member that is configured to be connectable to various light sources (e.g., a table lamp, a floor lamp, a chandelier, a pendant, and/or a wall scone, etc.), increasing the mounting versatility of the modular decorative lamp shade. The mounting hub may be secured to the light source by a finial. The mounting hub may further include a retaining ring forming an outside perimeter of the mounting hub. The retaining ring may include a plurality of flat outside edges, each of the flat outside edges having a mounting tab centered on each flat outside edge. The mounting tabs may be configured to be attachably connected to the plurality of panels by connecting each mounting tab to a respective mounting slot, the mounting slots located on the top portion of the inside surface of each of the plurality of panels. When the plurality of panels are connected to the mounting hub, each of the plurality of panels are configured to hang substantially perpendicular to a floor surface when the mounting hub is attached to a light source and the plurality of panels are each attached to a corresponding mounting tab. The decorative modular lamp shade device may also include a plurality of spokes, each of the spokes having a first end connected to the inner bracing member of the mounting hub and a second end connected to the retaining ring of the mounting hub. Additionally, the decorative modular lamp shade device may also be configured such that the outside surface of each of the panels is positioned to be facing away from the mounting hub when the mounting hub is attached to the light source and the plurality of panels are each attached to a respective mounting tab.

In some embodiments, the plurality of panels may further include a decorative substrate layer affixed to the inside surface of each of the plurality of panels. Additionally, in some embodiments, the mounting tabs may not be visible when viewing the outside surfaces of the plurality of panels. In some embodiments, the plurality of panels may be reversible such that the positioning of the outside surface may be swapped with the positioning of the inside surface of each panel when each panel of the plurality of panels is attached to its respective mounting tab. In some embodiments, there may be a decorative substrate layer affixed to both the inside surface and the outside surface of the plurality of panels such that a different decorative aspect may be viewed depending on the orientation of the panels when they are attached to the mounting hub. For example, the outside surface may include a first decorative aspect, and the inside surface may include a second decorative aspect that are distinct from one another.

### BRIEF DESCRIPTION OF THE DRAWINGS

Reference will now be made to the accompanying figures, which are not necessarily drawn to scale, and wherein:

FIG. 1A, FIG. 1B, and FIG. 1C show a mounting hub, in accordance with some exemplary embodiments. Specifically, FIG. 1A is a circular mounting hub, FIG. 1B is a square mounting hub, and FIG. 1C is a rectangular mounting hub, in accordance with some exemplary embodiments.

FIG. 2A and FIG. 2B show a three-dimensional prototype of a mounting hub, in accordance with an exemplary embodiment. Specifically, FIG. 2A is a top view and FIG. 2B is a side view of the mounting hub, in accordance with some exemplary embodiments.

FIG. 3 shows a three-dimensional prototype of a lamp shade device having a mounting hub and a plurality of panels, in accordance with an exemplary embodiment.

FIG. 4 shows a three-dimensional prototype of a mounting hub attachably connected to a light source, in accordance with an exemplary embodiment.

FIG. 5 shows a disassembled modular decorative lamp shade device, in accordance with an exemplary embodiment.

### DETAILED DESCRIPTION

The present disclosure can be understood more readily by reference to the following detailed description of example embodiments and the examples included herein. Before the example embodiments of the devices and methods according to the present disclosure are disclosed and described, it is to be understood that embodiments are not limited to those described within this disclosure. Numerous modifications and variations therein will be apparent to those skilled in the art and remain within the scope of the disclosure. It is also to be understood that the terminology used herein is for the purpose of describing specific embodiments only and is not intended to be limiting. Some embodiments of the disclosed technology will be described more fully hereinafter with reference to the accompanying drawings. This disclosed technology may, however, be embodied in many different forms and should not be construed as limited to the embodiments set forth therein.

In the following description, numerous specific details are set forth. However, it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Unless otherwise noted, the terms used herein are to be understood according to conventional usage by those of ordinary skill in the relevant art. In addition to any definitions of terms provided below, it is to be understood that as used in the specification and in the claims, “a” or “an” can mean one or more, depending upon the context in which it is used. Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Also, in describing the example embodiments, terminology will be resorted to for the sake of clarity. It is intended that each term contemplates its broadest meaning as understood by those skilled in the art and includes all technical equivalents that operate in a similar manner to accomplish a similar purpose.

To facilitate an understanding of the principles and features of the embodiments of the present disclosure, example embodiments are explained hereinafter with reference to their implementation in an illustrative embodiment. Such illustrative embodiments are not, however, intended to be limiting.

The materials described hereinafter as making up the various elements of the embodiments of the present disclosure are intended to be illustrative and not restrictive. Many suitable materials that would perform the same or a similar function as the materials described herein are intended to be embraced within the scope of the example embodiments. Such other materials not described herein can include, but are not limited to, materials that are developed after the time of the development of the invention, for example.

Embodiments of the disclosed technology include embodiments of a modular decorative lamp shade device, including modular decorative lamp shades for table lamps, floor lamps, chandeliers, pendants, wall scones, and any variations thereof. In various embodiments, a modular lamp shade device may include one or more innovations related to the design of the shade portion. In particular, a modular decorative lamp may be comprised of a plurality of panels collectively making up the shade portion of the lamp shade device allowing a high level of customizability of the decorative aspects of the lamp shade device. Further, the plurality of panels may be configured to conveniently connect to a mounting hub of the lamp shade device such that the panels hang substantially perpendicular to a floor surface when the mounting hub is attached to the light source and the plurality of panels are each attached to a corresponding mounting tab. Further, the mounting tabs of the mounting hub may be substantially hidden from view when each mounting tab is attached to a corresponding mounting slot of the plurality of panels when viewing the outside surfaces of the plurality of panels. Further, the lamp shade device may be configured to be easily and conveniently disassembled and laid substantially flat for transportation and storage. Accordingly, a lamp shade device constructed as disclosed herein is desirable for the improvements to its decorative function, customizability, and its ability to be disassembled and laid substantially flat for transportation or storage when not in use.

Throughout this disclosure, certain embodiments are described in exemplary fashion in relation to an improved lamp shade device. However, it should be understood that a lamp shade device is an integral part of a lamp, and accordingly, this disclosure contemplates the creation of lamps that integrate the embodiments of the modular decorative lamp shade device described herein. As those of skill in the art will appreciate, a lamp may be constructed by attaching a light source (e.g., a floor lamp, a table lamp, a chandelier, a pendant, and/or a wall scone, etc.) to the inner bracing member of the mounting hub of a lamp shade device described herein.

In one aspect of the invention, a modular lamp shade device is disclosed. The lamp shade device may include a plurality of panels, each having an inside surface, an outside surface, a transparent material, and a mounting slot located on a top portion of the inside surface of each panel. The modular lamp shade device may further include a mounting hub having an inner bracing member configured to be attachably connected to a light source, a retaining ring forming an outside perimeter of the mounting hub and having a plurality of flat outside edges. Each of the plurality of flat outside edges may have a mounting tab centered on each flat outside edge, with each mounting tab configured to be attachably connected to each of the plurality of panels at the mounting slot. The plurality of panels may hang substantially perpendicular to a floor surface when the mounting hub is attached to the light source and the plurality of panels is attached to corresponding mounting tabs. The mounting hub may be secured to the light source by a finial. The mounting hub may further include a plurality of spokes having a first end connected to the inner bracing member and a second end connected to the retaining ring. The outside surface of each of the plurality of panels may be positioned to be facing away from the mounting hub when the mounting hub is attached to the light source and the plurality of panels are each attached to respective mounting tab.

In some embodiments, the plurality of panels further include a decorative substrate affixed to the outside surface. In some embodiments, the decorative substrate may be partially transparent. In some embodiments, the decorative substrate may be affixed to the outside surface with an adhesive. In some embodiments, the decorative substrate may be affixed to the inside surface. In some embodiments, the plurality of panels may be reversible such that the positioning of the outside surface may be swapped with the positioning of the inside surface of each panel when each panel of the plurality of panels is attached to its respective mounting tab. In some embodiments, there may be a decorative substrate layer affixed to both the inside surface and the outside surface of the plurality of panels such that a different decorative aspect may be viewed depending on the orientation of the panels when they are attached to the mounting hub. For example, the outside surface may include a first decorative aspect, and the inside surface may include a second decorative aspect that are distinct from one another.

In some embodiments, the modular lamp shade device may be configured to lay substantially flat when disassembled into its component parts of the plurality of panels and the mounting hub. In some embodiments, each of the plurality of panels may include acrylic, glass, and/or plastic.

In some embodiments, the mounting slot may be configured to attachably connect to a corresponding mounting hub such that the mounting tab is not visible when viewing the outside surfaces of the plurality of panels. In some embodiments, the mounting hub may be substantially circular in shape. In some embodiments, the mounting hub may be substantially rectangular in shape. In some embodiments, the mounting hub may include metal.

In another aspect of the invention a modular lamp shade device is disclosed. The modular lamp shade may include a plurality of decorative panels. The decorative panels may include an inside surface, an outside surface, a transparent panel material, a decorative substrate affixed to the outside surface, and a mounting slot located on a top portion of the inside surface of a panel of the plurality of panels. The modular lamp shade may include a mounting hub. The mounting hub may include an inner bracing member configured to be attachably connected to a light source, a retaining ring forming an outside perimeter of the mounting hub and having a plurality of flat outside edges. The mounting hub may be secured to the light source by a finial. Each of the plurality of flat outside edges may have a respective mounting tab centered on each flat outside edge. The mounting tabs may be configured to be attachably connected to each of the plurality of decorative panels such that each of the plurality of decorative panels hangs substantially perpendicular to a floor surface when the mounting hub is attached to the light source and the plurality of decorative panels are attached to corresponding mounting tabs. The mounting hub may further include a plurality of spokes having a first end connected to the inner bracing member and a second end connected to the retaining ring. The outside surface of each of the decorative panels may be positioned to be facing away from the mounting hub when the mounting hub is attached to the light source and each of the plurality of panels is attached to a respective mounting tab. Each of the mounting tabs may be configured to attachably connect to a corresponding mounting slot such that each of the mounting tabs is not visible when viewing the outside surfaces of the panels.

In some embodiments, the decorative substrate may be partially transparent. In some embodiments, the decorative substrate may be affixed to the outside surface with an adhesive. In some embodiments, the modular lamp shade device may be configured to lay substantially flat when disassembled into its component parts of the plurality of panels and the mounting hub. In some embodiments, the decorative substrate may be affixed to the inside surface. In some embodiments, the plurality of panels may be reversible such that the positioning of the outside surface may be swapped with the positioning of the inside surface of each panel when each panel of the plurality of panels is attached to its respective mounting tab. In some embodiments, there may be a decorative substrate layer affixed to both the inside surface and the outside surface of the plurality of panels such that a different decorative aspect may be viewed depending on the orientation of the panels when they are attached to the mounting hub. For example, the outside surface may include a first decorative aspect, and the inside surface may include a second decorative aspect that are distinct from one another.

In some embodiments, each of plurality of panels may include acrylic, glass, and/or plastic. In some embodiments, the mounting hub may include metal.

In another aspect of the invention, a modular lamp shade device is disclosed. The modular lamp shade device may include a plurality of panels, each having an inside surface, an outside surface, a transparent panel material, and a mounting slot located on a top portion of the inside surface of each panel. The modular lamp shade device may further include a mounting hub. The mounting hub may include an inner bracing member configured to be attachably connected to a light source and a retaining ring forming an outside perimeter of the mounting hub and having a plurality of flat outside edges. The mounting hub may be secured to the light source by a finial. Each of the plurality of flat outside edges may have a respective mounting tab centered on each flat outside edge. Each mounting tab may be configured to be attachably connected to each of the plurality of panels such that each of the plurality of panels hangs substantially perpendicular to a floor surface when the mounting hub is attached to the light source and the plurality of panels are attached to corresponding mounting tabs. The mounting hub may further include a plurality of spokes having a first end connected to the inner bracing member and a second end connected to the retaining ring. The outside surface of each of the plurality of panels may be positioned to be facing away from the mounting hub when the mounting hub is attached to the light source and the plurality of panels are each attached to a respective mounting tab. The mounting slot may be configured to attachably connect to a corresponding mounting tab such that the mounting tab may not be visible when viewing the outside surfaces of the plurality of panels.

In some embodiments, the modular lamp shade device may be configured to lay substantially flat when disassembled into its component parts of the plurality of panels and the mounting hub. In some embodiments, each of plurality of panels may include acrylic, glass, and/or plastic and the mounting hub may include metal. In some embodiments, each of the plurality of panels may further include a decorative substrate affixed to the outside surface. In some embodiments, the decorative substrate may be affixed to the inside surface. In some embodiments, the plurality of panels may be reversible such that the positioning of the outside surface may be swapped with the positioning of the inside surface of each panel when each panel of the plurality of panels is attached to its respective mounting tab. In some embodiments, there may be a decorative substrate layer affixed to both the inside surface and the outside surface of the plurality of panels such that a different decorative aspect may be viewed depending on the orientation of the panels when they are attached to the mounting hub. For example, the outside surface may include a first decorative aspect, and the inside surface may include a second decorative aspect that are distinct from one another.

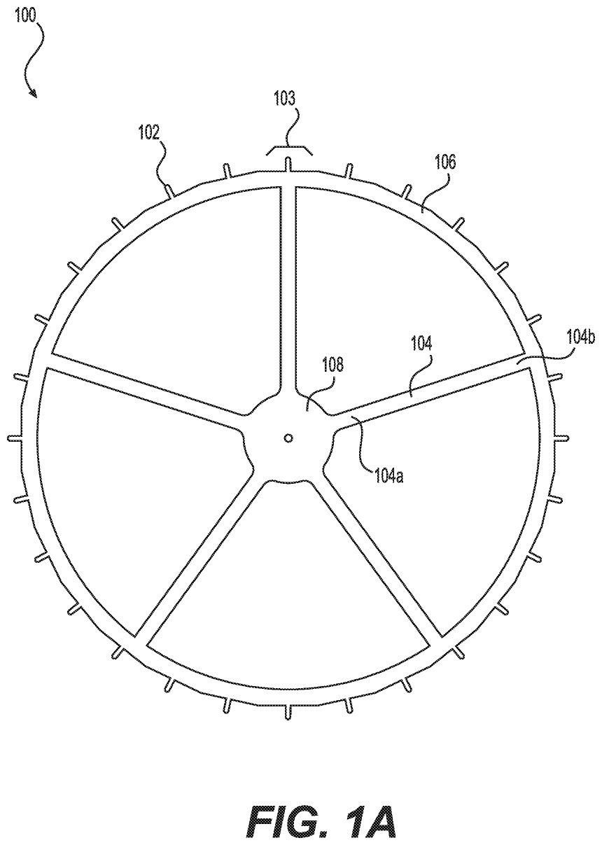

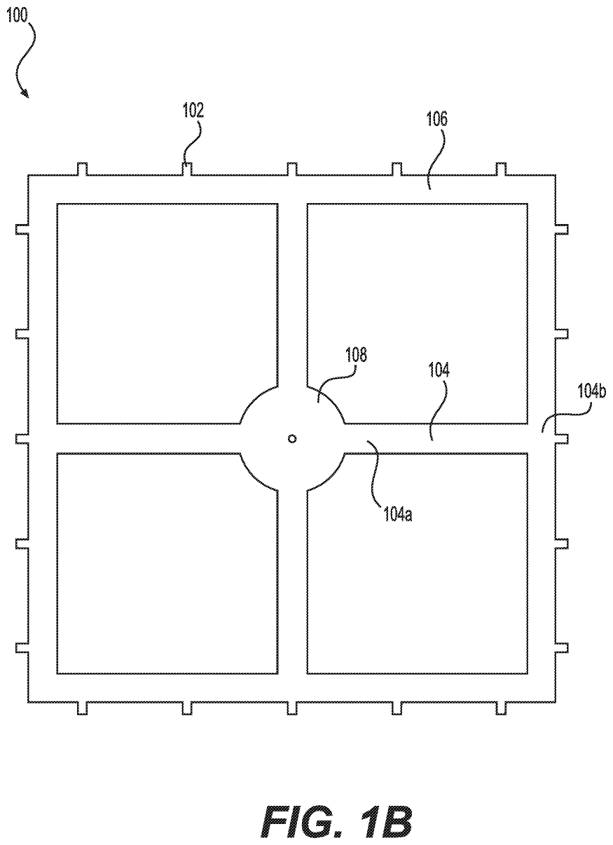

Referring now to the drawings, FIG. 1A, FIG. 1B, and FIG. 1C illustrate example embodiments of mounting hub 100. As shown in FIGS. 1A-1C, mounting hub 100 may be constructed in various sizes and shapes. FIG. 1A is an example embodiment of a circular mounting hub 100. FIG. 1B is an example embodiment of a square mounting hub 100. FIG. 1C is an example embodiment of a rectangular mounting hub 100. As shown in FIGS. 1A-1C, mounting hub 100 may have an inner bracing member 108 that is configured to be attachably connected to a light source, such as a floor lamp, a table lamp, a chandelier, a pendant, and/or a wall scone. Inner bracing member 108 may attach to a light source using any traditional attachment means, for example but not limited to a harp fitter, a light bulb clip, a washer and spider connector, a hurricane or chimney fitter, a threaded UNO fitter, a reflector bowl fitter, a Nardi or Slip UNO fitter, a Euro fitter, and the like. The outside perimeter of mounting hub 100 may include a retaining ring 106. In some embodiments, the retaining ring 106 may be substantially circular (e.g., as shown in FIG. 1A). In other embodiments, the retaining ring 106 may be substantially square or rectangular (e.g., as shown in FIG. 1B or FIG. 1C, respectively). As shown in FIG. 1A, the retaining ring 106 may include a plurality of flat outside edges 103, wherein each of the plurality of flat outside edges 103 may have a respective mounting tab 102 centered on its respective flat outside edge 103. The retaining ring 106 and inner bracing member 108 may be connected by a plurality of spokes 104. Each of the plurality of spokes 104 may have a first end 104a connected to the inner bracing member 108 and a second end 104b connected to the retaining ring 106. Each mounting tab 102 may be configured to be attachably connected to a panel of the plurality of panels (not shown).

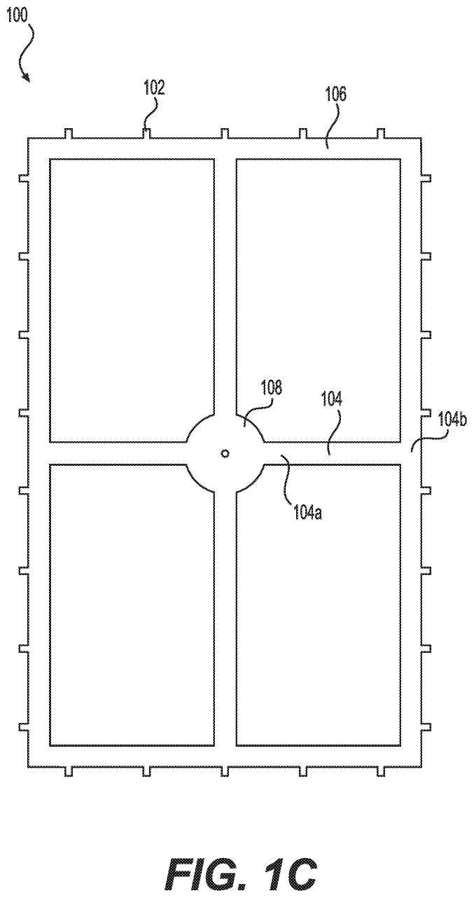

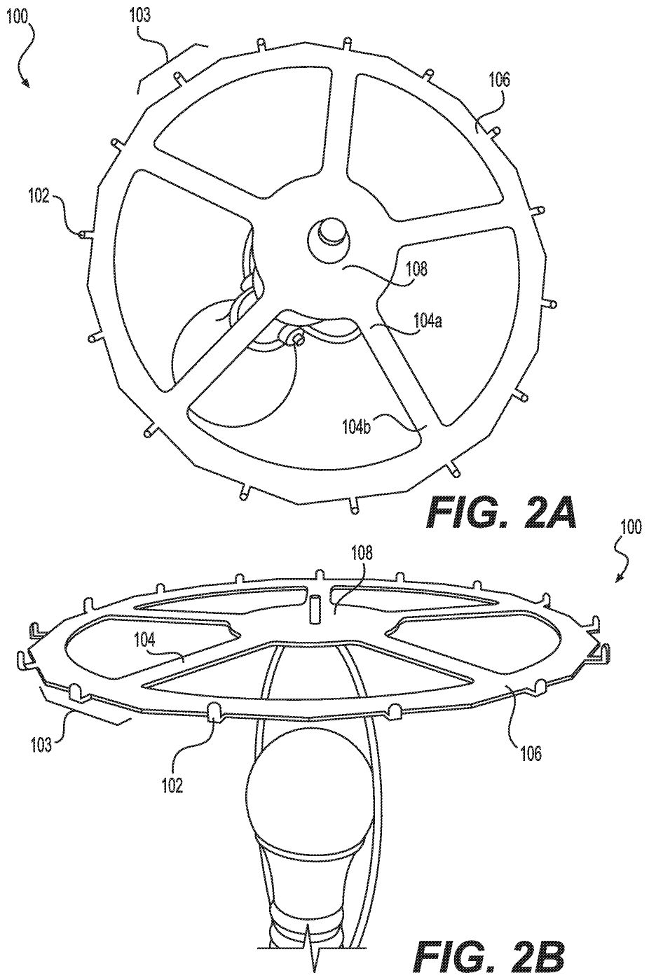

FIG. 2A and FIG. 2B show a top view and side view of a three-dimensional prototype of a mounting hub, respectively. As shown in FIG. 2A, mounting hub 100 may have an inner bracing member 108 that is configured to be attachably connected to a light source, such as a floor lamp, a table lamp, a chandelier, a pendant, and/or a wall scone. Inner bracing member 108 may attach to a light source using any traditional attachment means, for example but not limited to a harp fitter, a light bulb clip, a washer and spider connector, a hurricane or chimney fitter, a threaded UNO fitter, a reflector bowl fitter, a Nardi or Slip UNO fitter, a Euro fitter, and the like. The outside perimeter of mounting hub 100 may include a retaining ring 106. The retaining ring 106 may include a plurality of flat outside edges 103, wherein each of the plurality of flat outside edges 103 may have a respective mounting tab 102 centered on its respective flat outside edge 103. The retaining ring 106 and inner bracing member 108 may be connected by a plurality of spokes 104. Each of the plurality of spokes 104 may have a first end 104a connected to the inner bracing member 108 and a second end 104b connected to the retaining ring 108. Each mounting tab 102 may be configured to be attachably connected to a panel of the plurality of panels (not shown). In some embodiments, mounting tab 102 may be configured to allow the attached panels (not shown) to hang substantially perpendicular to the floor when inner bracing member 108 of mounting hub 100 is attached to a light source (e.g., a lamp) and the plurality of panels are attached to corresponding mounting tabs 102.

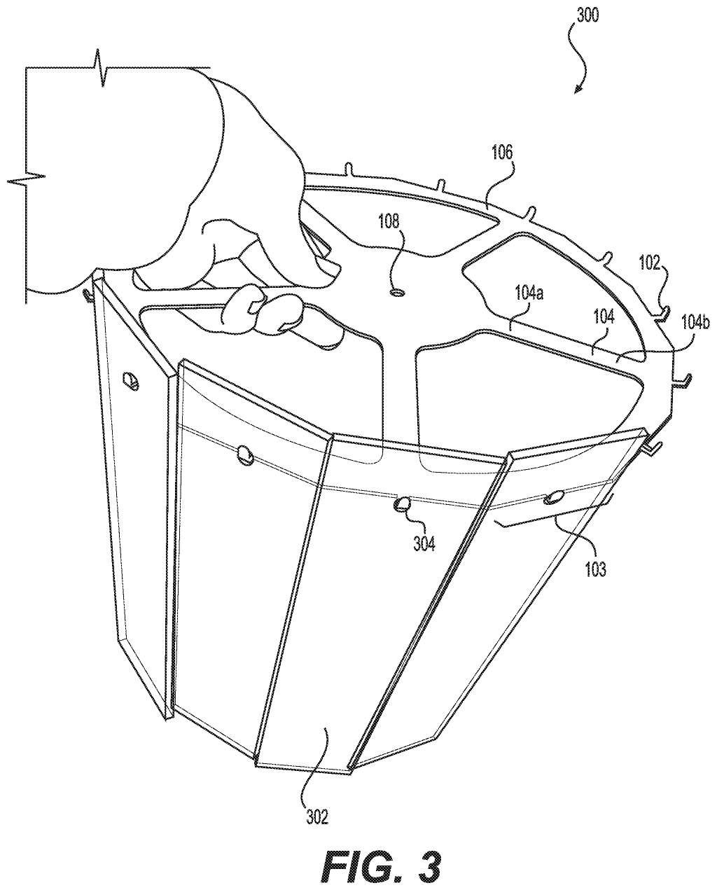

FIG. 3 is an image of a three-dimensional prototype of a lamp shade device, according to an exemplary embodiment. As shown in FIG. 3, mounting hub 100 may have an inner bracing member 108 that is configured to be attachably connected to a light source, such as a such as a floor lamp, a table lamp, a chandelier, a pendant, and/or a wall scone. Inner bracing member 108 may attach to a light source using any traditional attachment means, for example but not limited to a harp fitter, a light bulb clip, a washer and spider connector, a hurricane or chimney fitter, a threaded UNO fitter, a reflector bowl fitter, a Nardi or Slip UNO fitter, a Euro fitter, and the like. The outside perimeter of mounting hub 100 may include a retaining ring 106. The retaining ring 106 may include a plurality of flat outside edges 103, wherein each of the plurality of flat outside edges 103 may have a respective mounting tab 102 centered on its respective flat outside edge 103. The retaining ring 106 and inner bracing member 108 may be connected by a plurality of spokes 104. Each of the plurality of spokes 104 may have a first end 104a connected to the inner bracing member 108 and a second end 104b connected to the retaining ring 108. FIG. 3 also shows how a plurality of panels 302 may attach to a respective mounting tab 102 via mounting slot 304, located on an inside surface of a top portion of panel 302. According to some embodiments, when inner bracing member 108 of mounting hub 100 is attached to a light source (e.g., a lamp) resting on a flat surface, each of the plurality of panels 302 may hang substantially perpendicular to the flat surface when each panel 302 of the plurality of panels is attachably connected to the mounting hub 100 by attaching mounting tab 102 to mounting slot 304 of each panel 302. According to some embodiments, lamp shade device may be conveniently disassembled to lay substantial flat when being packaged for storage or shipment. In some embodiments, each of the plurality of panels 302 may be decorated with a decorative substrate (not shown), which may be affixed to the outside surface of each panel 302. In some embodiments, the decorative substrate may be partially transparent. The decorative substrate may be made of any suitable material, such as cloth, paper, lace, and/or wallpaper. In some embodiments, the decorative substrate may consist of bark, pressed flowers, or other plant materials. In some embodiments, the decorative substrate may consist of photographs which may be affixed to the plurality of panels in a similar manner to any of the other example decorative substrates. In some embodiments, the decorative substrate paper may be handmade and embedded with wood fibers, pressed flowers, bark, or other plant materials. In some embodiments, the decorative substrate may be affixed to the outside surface using an adhesive (e.g., glue), but other attachment means are not precluded. In some embodiments, the decorative substrate may be affixed to the inside surface of each panel 302. In some embodiments, the plurality of panels 302 may be reversible such that the positioning of the outside surface may be swapped with the positioning of the inside surface of each panel when each panel of the plurality of panels 302 is attached to its respective mounting tab. In some embodiments, the plurality of panels 302 may be composed of acrylic, glass, or plastic. In some embodiments, there may be a decorative substrate layer affixed to both the inside surface and the outside surface of the plurality of panels such that a different decorative aspect may be viewed depending on the orientation of the panels when they are attached to the mounting hub. For example, the outside surface may include a first decorative aspect, and the inside surface may include a second decorative aspect that are distinct from one another.

According to some embodiments, the panels 302 may be of different color tints, or may be substantially clear. In some embodiments, mounting slot 304 may be configured to attachably connect to a corresponding mounting tab 102 such that the mounting tab 102 may not be visible when viewing the outside surfaces of the plurality of panels 302. In some embodiments, the mounting hub 100 may be constructed of metal, but any sufficiently durable material may be used. According to some embodiments, the mounting hub may be powder coated to enhance the decorative aspects of the lamp shade device.

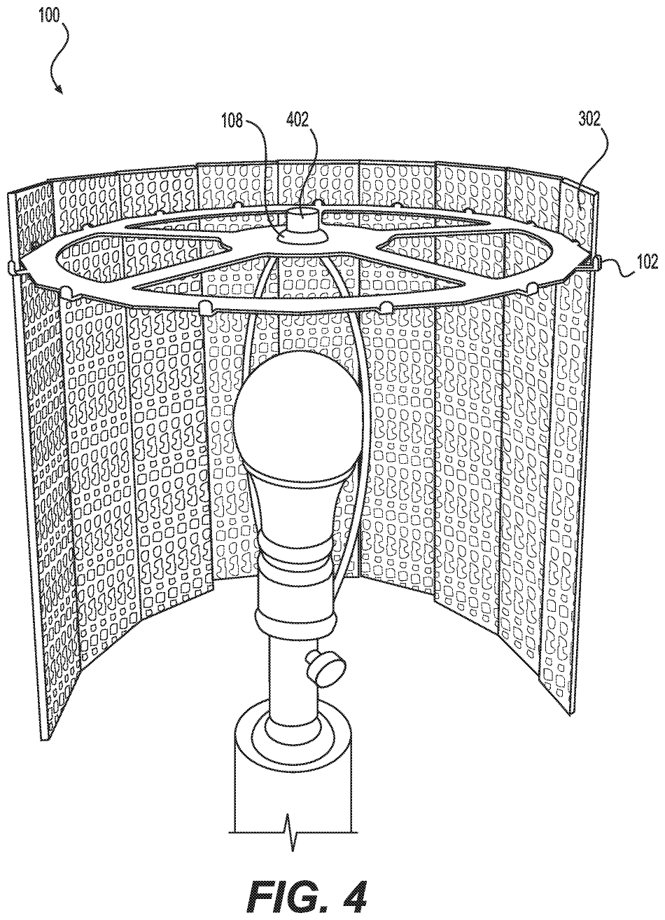

FIG. 4 is an image of a three-dimensional prototype of a mounting hub 100 attached to a light source, according to an exemplary embodiment. As shown in FIG. 4, the mounting hub 100 may be attachably connected to a light source via the inner bracing member 108 of mounting hub 100. In some embodiments, when inner bracing member 108 of mounting hub 100 is attached to a light source (e.g., a lamp) resting on a flat surface, each of the plurality of panels 302 may hang substantially perpendicular to the flat surface when each panel 302 of the plurality of panels is attachably connected to the mounting hub 100 by attaching mounting tab 102 to mounting slot 304 of each panel 302. Inner bracing member 108 may attach to a light source using any traditional attachment means, for example but not limited to a harp fitter, a light bulb clip, a washer and spider connector, a hurricane or chimney fitter, a threaded UNO fitter, a reflector bowl fitter, a Nardi or Slip UNO fitter, a Euro fitter, and the like. Inner bracing member 108 may be secured to a light source by finial 402. Finial 402 may have a threaded base configured to attachably connect to a light source and secure inner bracing member 108 to the light source, although other means of securing inner bracing member 108 to a light source by final 402 are not precluded.

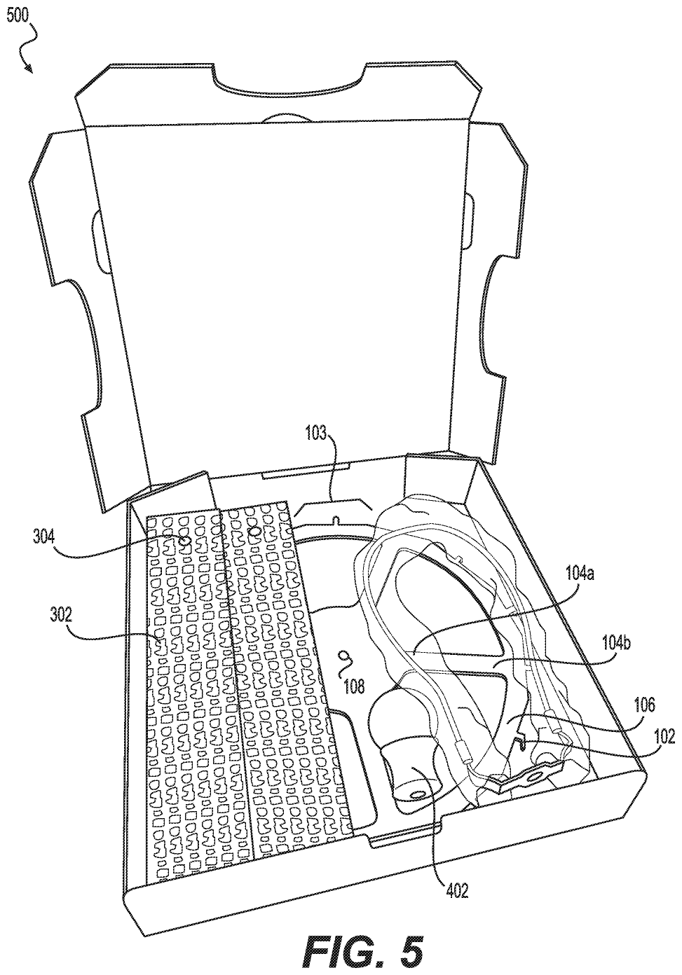

FIG. 5 shows a disassembled modular decorative lamp shade device, in accordance with an exemplary embodiment. In some embodiments, the lamp shade device may be configured to allow a user to conveniently disassemble the lamp shade device into its component parts of mounting hub 100, the plurality of panels 302, and finial 402. When the lamp shade device is disassembled, it may be laid substantially flat for convenient storage or shipment, improving the convenience and functionality of the lamp shade device over traditional lamp shades. In some embodiments, inner bracing member 108 may be secured to a light source by finial 402. Finial 402 may have a threaded base configured to attachably connect to a light source and secure inner bracing member 108 to the light source. In some embodiments, the plurality of panels 302 may include a decorative substrate affixed to the inside or outside surface of the plurality of panels 302. In some embodiments, the decorative substrate affixed to the plurality of panels 302 may be reversible such that the positioning of the outside surface may be swapped with the positioning of the inside surface of each panel when each panel of the plurality of panels 302 is attached to its respective mounting tab, adding to the modular lamp shade's ability to be personalized. In some embodiments, there may be a decorative substrate layer affixed to both the inside surface and the outside surface of the plurality of panels such that a different decorative aspect may be viewed depending on the orientation of the panels when they are attached to the mounting hub. For example, the outside surface may include a first decorative aspect, and the inside surface may include a second decorative aspect that are distinct from one another.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A modular lamp shade device comprising:
a plurality of panels, each comprising:
an inside surface;
an outside surface;
a transparent panel material; and
a mounting slot located on a top portion of the inside surface of a panel of the plurality of panels;
a mounting hub comprising:
an inner bracing member configured to be attachably connected to a light source;
a retaining ring forming an outside perimeter of the mounting hub and having a plurality of linearly flat outside edges, each of the plurality of linearly flat outside edges having a respective mounting tab centered on its respective linearly flat outside edge and configured to be attachably connected to each of the plurality of panels at the mounting slot such that each of the plurality of panels hangs substantially perpendicular to a floor surface when the mounting hub is attached to the light source and the plurality of panels is attached to corresponding mounting tabs; and
a plurality of spokes having a first end connected to the inner bracing member and a second end connected to the retaining ring; and
wherein the outside surface of each of the plurality of panels is positioned to be facing away from the mounting hub when the mounting hub is attached to the light source and the plurality of panels are each attached to a respective mounting tab.

2. The device of claim 1, wherein the plurality of panels further comprise a decorative substrate affixed to the outside surface.

3. The device of claim 2, wherein the decorative substrate is partially transparent.

4. The device of claim 2, wherein the decorative substrate is affixed to the outside surface with an adhesive.

5. The device of claim 1, wherein the modular lamp shade device is configured to lay substantially flat when disassembled into its component parts of the plurality of panels and the mounting hub.

6. The device of claim 1, wherein each of the plurality of panels comprises acrylic.

7. The device of claim 1, wherein the mounting hub is configured to attach to the light source with a connector selected from one of a harp fitter, a light bulb clip, a washer and spider connector, a chimney fitter, a threaded UNO fitter a reflector bowl fitter, a Nardi UNO fitter, a slip UNO fitter, and a Euro fitter.

8. The device of claim 1, wherein the mounting hub is substantially circular in shape.

9. The device of claim 1, wherein the mounting hub is substantially rectangular in shape.

10. The device of claim 1, wherein the mounting hub comprises metal.

11. A modular lamp shade device comprising:
a plurality of decorative panels, each comprising:
an inside surface;
an outside surface;
a transparent panel material;
a decorative substrate affixed to the outside surface; and
a mounting slot located on a top portion of the inside surface of a panel of the plurality of panels;
a mounting hub comprising:
an inner bracing member configured to be attachably connected to a light source;
a retaining ring forming an outside perimeter of the mounting hub and having a plurality of linearly flat outside edges, each of the plurality of linearly flat outside edges having a respective mounting tab centered on its respective linearly flat outside edge and configured to be attachably connected to each of the plurality of decorative panels such that each of the plurality of decorative panels hangs substantially perpendicular to a floor surface when the mounting hub is attached to the light source and the plurality of decorative panels are attached to corresponding mounting tabs; and
a plurality of spokes having a first end connected to the inner bracing member and a second end connected to the retaining ring; and
wherein the outside surface of each of the plurality of decorative panels is positioned to be facing away from the mounting hub when the mounting hub is attached to the light source and each of the plurality of panels is attached to a respective mounting tab.

12. The device of claim 11, wherein the decorative substrate is partially transparent.

13. The device of claim 11, wherein the decorative substrate is affixed to the outside surface with an adhesive.

14. The device of claim 11, wherein the modular lamp shade device is configured to lay substantially flat when disassembled into its component parts of the plurality of panels and the mounting hub.

15. The device of claim 11, wherein each of the plurality of panels comprises acrylic.

16. The device of claim 11, wherein the mounting hub comprises metal.

17. A modular lamp shade device comprising:
a plurality of panels, each comprising:
an inside surface;
an outside surface;
a transparent panel material; and
a mounting slot located on a top portion of the inside surface of a panel of the plurality of panels;
a mounting hub comprising:
an inner bracing member configured to be attachably connected to a light source;
a retaining ring forming an outside perimeter of the mounting hub and having a plurality of linearly flat outside edges, each of the plurality of linearly flat outside edges having a respective mounting tab centered on its respective linearly flat outside edge and configured to be attachably connected to each of the plurality of panels such that each of the plurality of panels hangs substantially perpendicular to a floor surface when the mounting hub is attached to the light source and the plurality of panels are attached to corresponding mounting tabs; and
a plurality of spokes having a first end connected to the inner bracing member and a second end connected to the retaining ring; and
wherein the outside surface of each of the plurality of panels is positioned to be facing away from the mounting hub when the mounting hub is attached to the light source and the plurality of panels are each attached to a respective mounting tab.

18. The device of claim 17, wherein the modular lamp shade device is configured to lay substantially flat when disassembled into its component parts of the plurality of panels and the mounting hub.

19. The device of claim 17, wherein each of the plurality of panels comprises acrylic and wherein the mounting hub comprises metal.

20. The device of claim 17, wherein each of the plurality of panels further comprise a decorative substrate affixed to the outside surface.
